(19) United States
(12) Patent Application Publication
(10) Pub. No.: US 2004/0049490 A1
(43) Pub. Date: Mar. 11, 2004

(54) Intelligent document management system

(76) Inventor: David E. Milov, Orlando, FL (US)

Correspondence Address: Mark J. Young, McGuireWoods LLp, Suite 3300, 50 North Laura Street, Jacksonville, FL, 32202, US

(21) Appl. No.: 10/658,878

(22) Filed: Sep. 9, 2003

Related U.S. Application Data
(60) Provisional application No. 60/408,885, filed on Sep. 9, 2002.
(60) Provisional application No. 60/410,282, filed on Sep. 13, 2002.

(51) Int. Cl. G06F 7/00

(52) U.S. Cl. 707/1

(57) ABSTRACT

This system and method of the present invention is directed to a process of creating and using a medical database whereby the contents have been validated through a peer review process to produce an extensive searchable base of protocols and links to literature references by a given medical topic. The database is populated and indexed with protocols for both diagnosis and treatments. The protocols are created and reviewed with research evidence, which provides for establishing confidence levels. It is then subsequently categorized and indexed into a database system. This information can then be subsequently accessed by keywords by practitioners from the patient point of care location.

### PRIORITY CLAIM

This application claims priority to U.S. Provisional Application 60/408,885 filed Sep. 9, 2002, and to U.S. Provisional Application 60/410,282 filed Sep. 13, 2002, the entire contents of which are hereby incorporated by reference herein.

### BACKGROUND OF THE INVENTION

1. Field of the Invention

This invention relates to a document database, and more particularly, to a structured system and method for managing and providing peer reviewed documents.

2. Background Description

Providing confident and consistent medical advice and treatment to patients is a prime concern to doctors, medical professionals, and corporate health providers. Recognition of medical conditions and possible implications of indicators is a constant routine facing the daily actions of the medical profession. Diagnosing conditions depends considerably on the skill and resources of the personnel providing the service.

To diagnose a condition, doctors must often consider the possibility of competing conditions that present similar symptoms and indicators. Eliminating possible causes is often not a straight-foreword process. New diagnosis protocols are ever evolving and access to these newer identification possibilities can be problematic since medical literature is embodied in a multitude of journals, databases, periodicals, and the like and access to these may be very limited, inconsistent, or lo impractical. Additionally, establishing a confidence factor in new information can cause uncertainty in use of new information.

For example, various professional associations or groups associated with significant medical conditions or diseases are engaged in the study of the conditions and diseases of interest and in the generation of recommendations and guidelines for the treatment of the disease. These recommendations may change frequently as more is learned about the disease. The medical treatment industry, including pharmaceutical companies, medical equipment companies, hospitals and other medical treatment related enterprises are in turn engaged in the continuous development of new medications and methods for treatment of diseases or medical conditions, and recommendations for the use of the new medications or methods. Consequently, practitioners face increasingly complex decision making processes, involving increasing volumes and types of information and sources of information, increasing and continuously changing guidelines and requirements, and increasing numbers of medications and methods for treatment.

Providing a confident treatment for a diagnosis is also often subject to changing medical viewpoints. New treatments and alternatives to traditional choices are also ever evolving and access to this information is again problematic for the same accessibility and confidence factors.

Providing suitable information for the patient's use is also highly desired. Unfortunately, material is usually not scaled to the age or gender of the patient. Providing intensely phrased information to children is not appropriate, nor is providing literature for small children suitable for teens. There are certain health issues more prone to age brackets (e.g., acne for teens), therefore information should be tailored to address the patient's situation and maturity.

In private practices and corporate style health provider settings, providing the best diagnosis, treatments, and information using well established protocols that have been supported by medical research and thorough peer review by relevant medical professionals is becoming more important. Confidence in protocols provides more confidence in the overall treatment of patients and establishes consistency in overall health services. However, access to these protocols and information is not well developed or available.

While there are many on-line information retrieval systems available to practitioners and through which practitioners may search for and retrieve information pertaining to diagnostic symptoms, guidelines for treatment, medications and medication effects, and so on, such systems are essentially merely substitutes for traditional hard copy references.

The invention is directed to overcoming these problems.

### SUMMARY OF THE INVENTION

The system and method of the present invention is directed to a process of creating and using a medical database whereby the contents have been validated through a peer review process to produce an extensive searchable base of protocols and links to literature references by a given medical topic. The database is populated and indexed with protocols for both diagnosis and treatments. The protocols are created and reviewed with research evidence, which provides for establishing confidence levels. It is then subsequently categorized and indexed into a database system. This information can then be subsequently accessed by keywords by practitioners from the patient point of care location.

In one aspect of the invention, a computer implemented medical database is provided. The database includes a plurality of medical documents. Each of the documents has protocol information associated with it. Evidence levels are also associated with each of the documents. Each evidence level represents the validity of the protocol information for a document.

In another aspect of the invention, a method is provided for creating a medical database. The method entails assigning a topic, writing a document on the topic, submitting the document to peers for review and assignment of an evidence level, entering the document and the assigned evidence level for the document in a computer accessible database.

In a further aspect of the invention, a computer implemented medical database comprising a database means for storing a plurality of medical documents, associated protocol information, and associated evidence levels is provided. Each of the documents has associated protocol information and an evidence level.

Additional features, advantages, and embodiments of the invention may be set forth in or apparent from consideration of the following detailed description, drawings, and claims. Both the foregoing summary of the invention and the following detailed description are exemplary and intended to provide further explanation without limiting the scope of the invention as claimed.

### BRIEF DESCRIPTION OF THE DRAWINGS

The foregoing and other objects, features and advantages of the present invention will become better understood with reference to the following description, appended claims, and accompanying drawings, where:

FIG. 1 is a high-level block diagram of a distributed system on which an exemplary embodiment of the invention may be implemented;

FIGS. 2 and 3 are flowcharts that conceptually illustrate steps of exemplary processes for establishing a controlled content medical information database in accordance with the invention;

FIG. 4 is a flowchart that conceptually illustrates an exemplary management control methodology for a data creation (purification) process;

FIG. 5 illustrates an exemplary keyword search screen in accordance with the invention;

FIG. 6 illustrates possible search results for an exemplary query in accordance with the invention;

FIG. 7 shows an exemplary draft charting page containing information and hyperlinks to resources pertaining to asthma;

FIG. 8 shows results of an exemplary search for educational information concerning asthma;

FIGS. 9A and 9B illustrate an exemplary parent-oriented educational article 910 on “whooping cough”;

FIG. 10 shows a co-branded document in a printer friendly format for printing at a point of care;

FIG. 11 shows a login page for administrative access;

FIG. 12 shows an exemplary screen of entry controls, each of which provides access to screens for performing various functions, including entering and editing information;

FIG. 13 shows an exemplary purity template, which may be used to build a database of protocol documents in accordance with the invention;

FIG. 14 shows status indicators for available lists;

FIG. 15 shows a magnified portion of the template of FIG. 13 with an alternative version control indicator, namely, checkbox controls providing four possible versions; and

FIG. 16 shows the template of FIG. 13 with the icon “keyword” activated.

### DETAILED DESCRIPTION

The system and method of the present invention provides a medical database whereby the contents have been validated through a peer review process to produce an extensive searchable base of protocols and links to literature references by a given medical topic. The database is populated and indexed with protocols for both diagnosis and treatments. The protocols are created and reviewed with research evidence, which provides for establishing confidence levels. The database information thus reflects consensus from experts and is evidence driven. It is then subsequently categorized and indexed into a database system. It also includes best practice alerts and allows for impregnable audit trails. The information may then be subsequently accessed by keywords by practitioners from the patient point of care location. The end result is minimized medical errors.

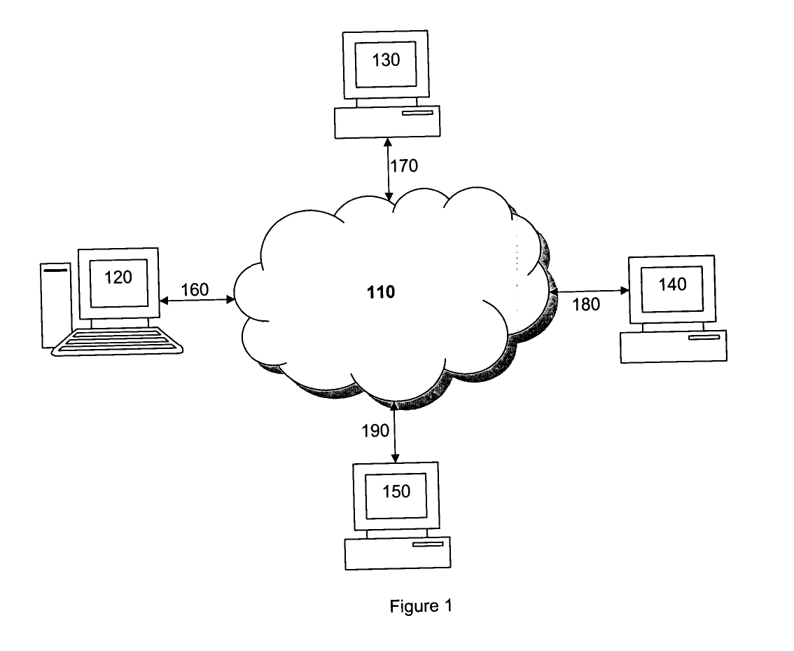

An exemplary intelligent document management system in accordance with the invention may be implemented on a distributed computer network. Referring to FIG. 1, a simplified block diagram of an exemplary distributed system on which an exemplary implementation of the invention may be implemented is shown. The computer network includes a plurality of client systems 130-150 and a server system 120 coupled to a communication network 110 via a plurality of communication links 160-190. The communication network 110 provides a mechanism for allowing the various components of the distributed system to communicate and exchange information with each other. The communication network 110 may itself be comprised of many interconnected computer systems and communication links. The communication links 160-190 may be hardwire links, optical links, satellite or other wireless communications links, wave propagation links, or any other mechanisms for communication of information. While in one embodiment, the communication network 110 includes the Internet, in other embodiments, the communication network 110 may be any suitable computer network.

Those skilled in the art will appreciate that the distributed system diagrammatically illustrated in FIG. 1 is merely an example of a system on which the present invention may be implemented and does not limit the scope of the invention. Variations, modifications and alternatives of the system may be used without departing from the scope of the invention. By way of example and not limitation, more than one server may be coupled to communication network. Additionally, although the invention is described using a client-server environment, the invention may also be embodied in or implemented on a stand-alone computer system. Furthermore, other configurations with fewer or more computers may be used to implement an intelligent document management system in accordance with the present invention.

The server 120 is responsible for obtaining and storing information for a plurality of medical documents and related information in order to facilitate document management in accordance with an exemplary implementation of the invention. The server 120 may store the information in one or more databases accessible to server. The databases may be locally coupled to server 120 or may be distributed across a distributed computer network and accessed by the server 120 via a communication network 160.

Software modules executing on the server 120 are configured to obtain information from a plurality of information sources, and process, integrate and store the information in a manner that facilitates document management in accordance with an exemplary implementation of the invention. The information sources may include user input or other data sources accessible by the server. Software on the server 120 is also configured to provide services, such as allowing users to select, access, retrieve, input, edit and query information stored by the server.

The server 120 is configured to receive information requests from clients 130-150, performing processing required to satisfy the requests, and for forwarding the results corresponding to the requests back to the requesting client system. The processing required to satisfy the request may be performed by server 120 or may alternatively be delegated to other servers connected to communication network 110.

The clients 130-150 enable users to access, input, edit, display and query information stored by the server 120. In a specific embodiment, web browser applications (e.g., the Internet Explorer browser program provided by Microsoft Corporation or the Netscape Navigator browser provided by Netscape Corporation) executing on the client systems 130-160 enable users to select, access, retrieve, or query information stored by server system.

Each computing device 120-150 may, by way of example and not limitation, be a conventional computer with a processing unit, a system memory and a system bus that communicatively couples various system components including the system memory to the processing unit. The system bus may be any of various types of bus structures using any of a variety of bus architectures. The system memory may include read only memory (ROM) and random access memory (RAM). A basic input/output system (BIOS), containing routines that help to transfer information between elements within the computer may be stored in ROM. The computer may also include mass storage devices such as a magnetic hard disk drive connected to the system bus by a hard disk drive interface to provide nonvolatile storage of computer readable instructions, data, software applications and modules and other files and information. While client computers 130-150 and the server 120 may generally have the same configuration, the server 120 may have more storage capacity 130-150 and computing power than the client systems. These elements are typically included in most computer systems and the aforementioned system is intended to represent a broad category of computers supporting transmission, receipt and processing of information in accordance with the invention.

Many other computer configurations are possible without departing from the scope of the invention. For example, each computing device may include fewer, different and/or additional elements, provided it is capable of performing steps in accordance with the invention. Those skilled in the art will appreciate that the invention may be practiced with computing devices other than conventional personal computers, including, without limitation, hand-held devices, multi-processor systems, mainframes, minicomputers and dumb terminals. Each computing device may further function as an integral part of another distributed computing environment, where tasks may be performed by remote processing devices linked through a communications network with program modules located in local and/or remote storage devices.

Back-End—Purity

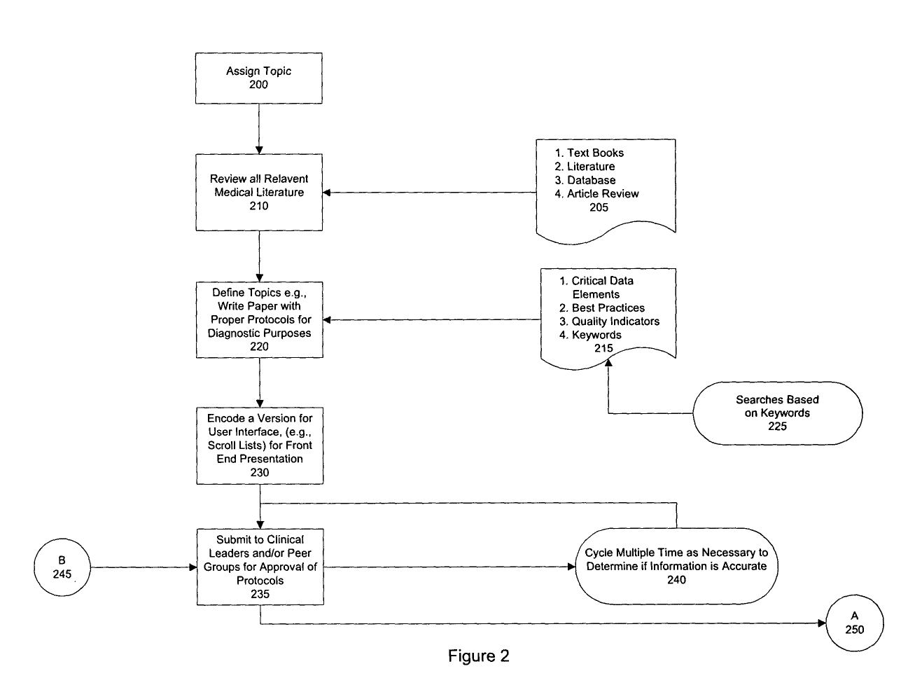

Referring to FIG. 2, a flowchart conceptually illustrates steps of an exemplary process for establishing a controlled content medical information database in accordance with the invention. These steps comprise a back-end part of the system. The process of creating a high-quality reference database in accordance with an exemplary implementation of the present invention is referred to herein as purification or purity. In general, the exemplary process entails defining topics, writing papers that provide a determined scope of coverage, encoding papers for presentation using the system, submitting the paper for peer review, determining an evidence level based on validity, establishing granularity for encoding into the database and, optionally, establishing links. In sum, purity provides a structured methodology for managing clinical content desired for a medical database.

Starting at step 200, a topic is decided upon and assigned for research. In practice, multiple topics may be assigned simultaneously. Illustratively, a topic may be asthma, or another condition or a disease.

Next, the topic is researched, as in step 210. The research may entail reviewing available medical literature such as journals, textbooks, databases, articles and the like, as shown in step 205. Research may be conducted in an ongoing manner (e.g., continuously or periodically), with work product updated over time to reflect then current research findings.

As the process continues, associated topics and subtopics may be defined. Then, a paper or document may be written with proper protocols for diagnosing and treating purposes, as shown by step 220. The paper may be supported by critical data elements, support citations, best practice opinions by those recognized in the field showing most promising results, quality indicators for the protocols including statistical evidence, and a keyword citation listing relevant to the topic, as shown in 215. The keyword list provides an accessibility range to the medical citations by practitioners. The keywords may then be introduced into the medical database to provide users search access to the supporting protocols and backup information, according to 225.

Once a paper is prepared, it may be encoded for front-end user interface presentation (i.e., display), as in step 230. By way of example, the paper may be encoded into a particular language or format, such as hypertext markup language or extensible markup language, that is compatible with client side hardware and software (e.g., a web browser).

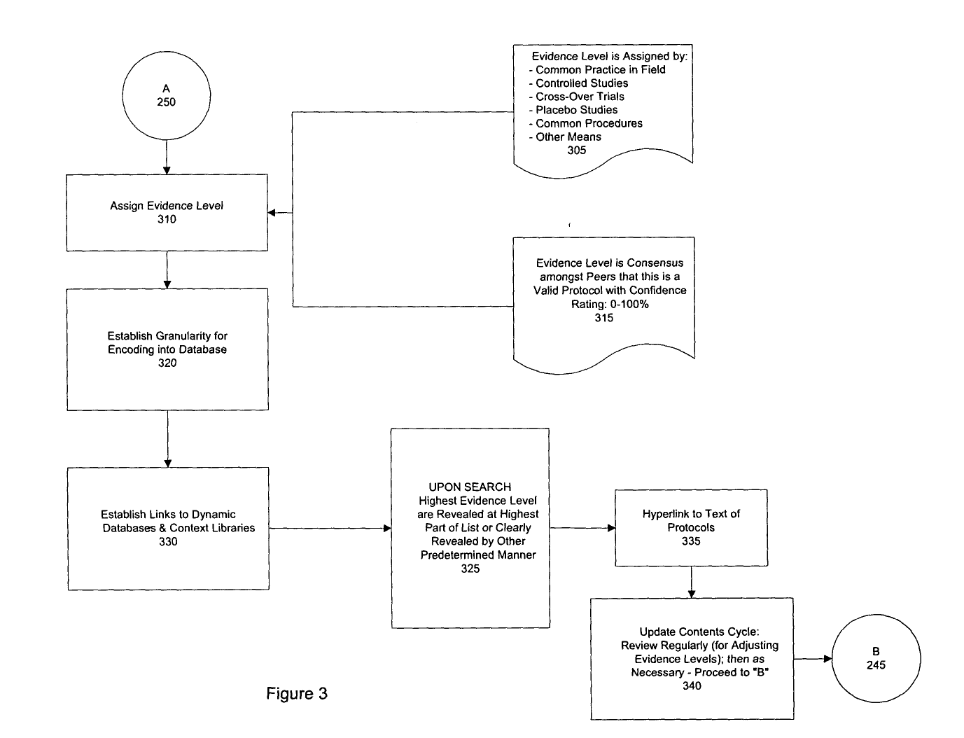

Then in step 235, the topic paper or papers, which may include best practice proposals, and associated screen presentations as appropriate, are submitted to a control process of review. Clinical leaders and medical peer groups may review the paper, according to step 235. The integrity and content of the paper and presentation of the content may be iteratively reviewed until a consensus is reached, as in step 240. Upon reaching a consensus, the submitted paper is considered validated and control passes to 250 in FIG. 3.

Referring now to FIG. 3, step 310, an evidence level may be assigned. The evidence level may be based on consensus among peers that the documented protocols are valid, with a confidence rating from 0 to 100%, as in step 315. A high evidence level indicates that the protocol is considered valid by the reviewing peers, while a low evidence level reveals that peers consider the protocol to have a questionable validity. Other measurement or rating techniques by peers and/or others concerning the validity or efficacy of the documented protocol may be utilized without departing from the scope of the present invention. The evidence level may be based upon various support factors, including common practice in the field, controlled studies, cross-over trials, placebo studies, common procedures and any other means of assessing validity, as in step 305. These factors and others may be considered to rate and quantify the efficacy, validity and/or level of confidence for the documented protocol, without departing from the scope of the present invention.

Appropriate review assesses the level of detail or granularity of the data documented. In step 320, the granularity of access to a level of information is established. This provides a consensus as to the most appropriate level of detail that can be accessed during a search. A high granularity would mean that the content is divided into many small, labeled segments. The more detailed the segments, the more specifically one can search by segment label. The encoded result may then be stored or tagged within a database.

In step 330, the database is created and populated with the resulting protocols and appropriate links to supporting databases and context libraries for the topic areas.

Optionally, a search engine in accordance with an exemplary implementation of the invention may be configured to present topics and sub-topics, for a keyword in decreasing order of evidence level, i.e., with the highest evidence level most prominent. This may be achieved by an ordering or sorting.

Also optionally, hyperlinks to the text of protocols and supporting documents may be included in the presentation and database, as shown in step 335. Such hyperlinks greatly facilitate accessing the supporting materials.

As a further option, content may be re-reviewed periodically, such as annually, for changes in the evidence levels, as in step 340. If adjustments are necessary, the document may be resubmitted to the review cycle for consensus development. This may be accomplished at many different levels, such as for example, the practitioner's level. Accordingly, the exemplary system is iterative, allowing feedback from practitioners in order to update the evidence and validate the process, if applicable.

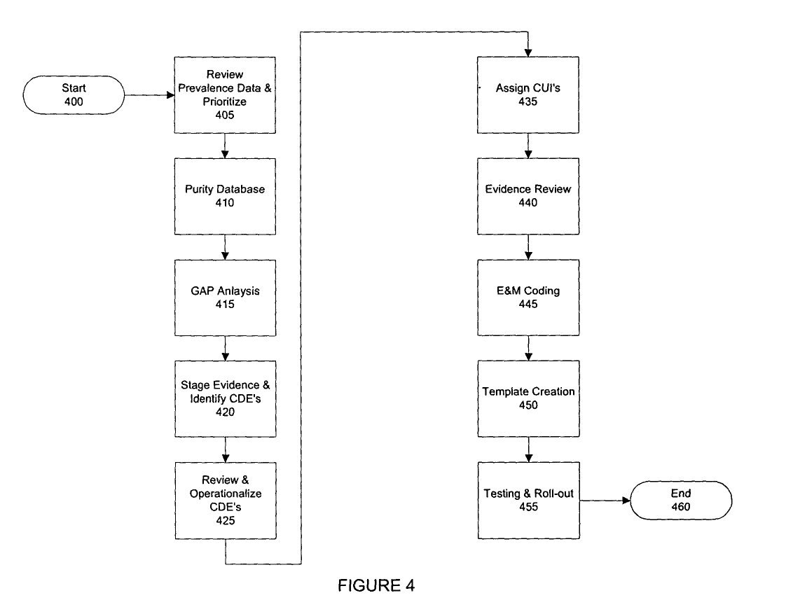

FIG. 4 is a flowchart that conceptually illustrates an exemplary management control methodology for a data creation (purification) process. A project manager may provide oversight of building, populating and editing the database. At step 405, a practitioner may be assigned to review prevalence data, which may identify a proportion of a population with particular conditions or diseases during a specified time period. Next, the reviewer may prioritize the data and generate a purity database for a select topic area, as in step 410.

The reviewer may then pass the topic to a clinical leader at a GAP (generally accepted practices) analysis stage, step 415. Next, evidence may be staged and preliminary critical data elements (CDE) may be identified, as in step 420. A list of CDEs may be provided and controlled by a participant (e.g., the clinical leader or reviewer).

Next, the clinical leader may review the CDEs and proceed to operationalize them, as in step 425. This step may entail placing the CDEs into operational format and encoding them.

Next, Concept Unique Identifiers (CUIs) are assigned, as in step 435. CUIs are codes that represent unique concepts, e.g., diseases and treatments. A CUI may (for example) be an 8-character identifier beginning with the letter “C” followed by 7 digits, e.g., C0123456. While the CUI itself may have no intrinsic meaning, it remains the same irrespective of the term (e.g., a synonym or acronym) designated as the preferred name of the concept. The CUI thus facilitates file maintenance and management and searching, by identifying information that relates to a given concept, irrespective of the terminology used.

Next, one or more additional evidence reviews may be performed, as in step 440. This usually entails peer review. After the additional review, industry standard Evaluation and Management (E/M) coding may be applied to identify types of patient examinations, evaluations and management, as in step 445.

After E&M coding, a template of the topic area is generated and populated, as in step 450. After final reviews, a pilot test is performed, as in step 455. Eventually the document is rolled-out for general use.

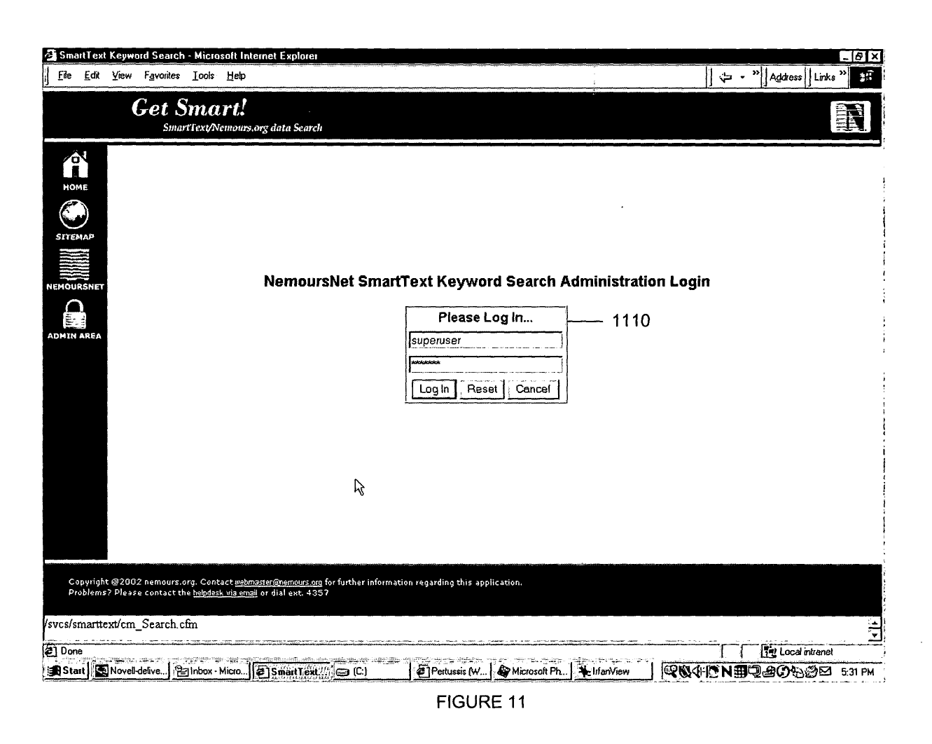

Administrative access to the purity database may be password protected. Referring to FIG. 11, a user name and password login 1110 are required for access.

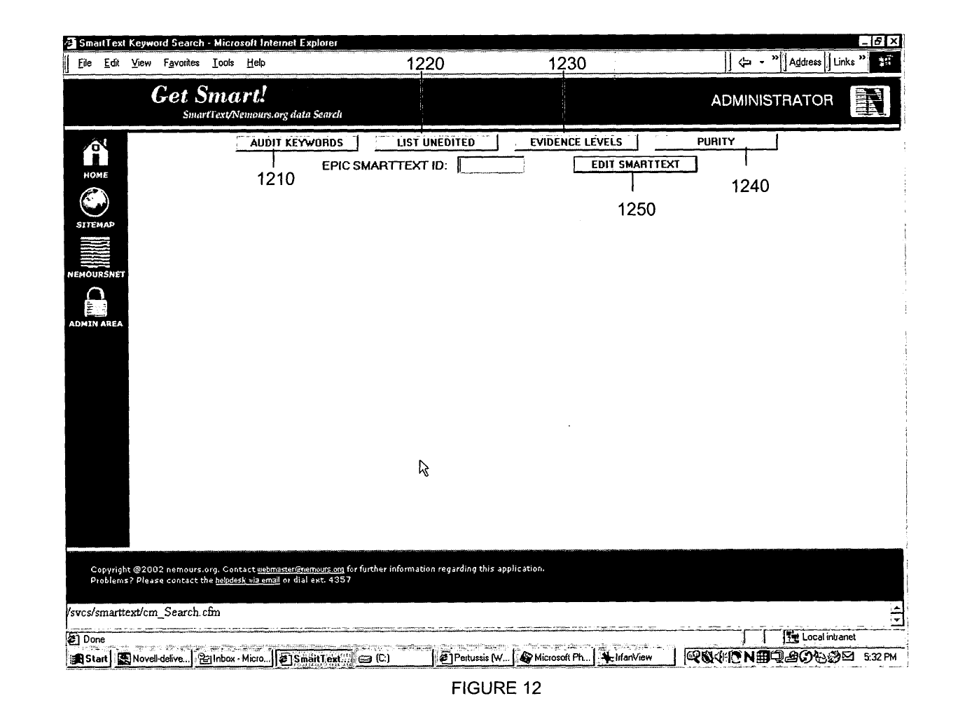

Upon login, the administrative user accesses a screen of entry controls, each of which provides access to screens for performing various functions, including entering and editing information, as shown in FIG. 12. The user may audit keywords (e.g., to correct keywords) 1210, list documents without keywords 1220, access assigned evidence 1230, edit SmartText 1250, or access a purity template 1240.

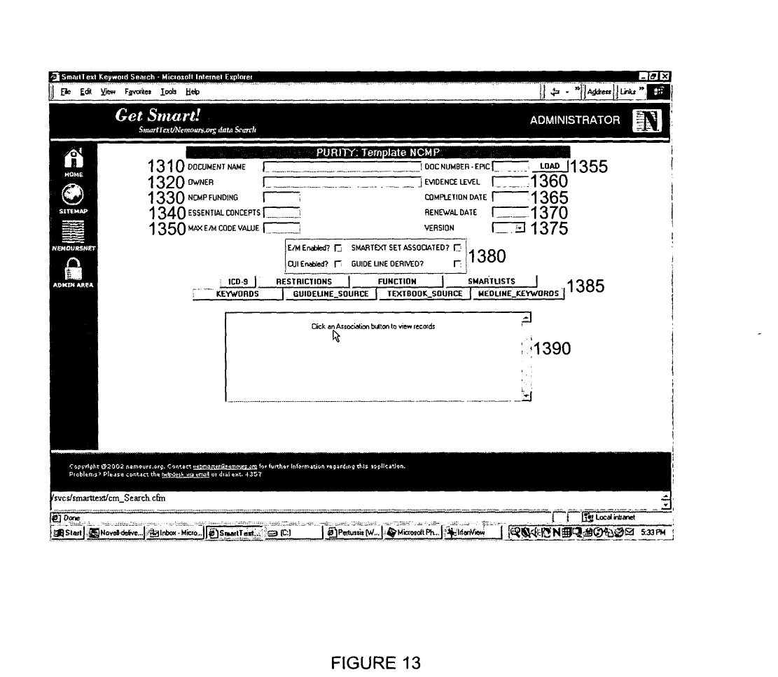

Referring now to FIG. 13, an exemplary purity template, which may be used to build a database of protocol documents in accordance with the invention, is shown. The document name 1310, owner (i.e., an originator or responsible party) 1320, funding information 1330 (e.g., insured or private pay), essential concepts (e.g., using a CUI) 1340, a maximum Evaluation & Management code 1350, a document number 1355, an evidence level 1360, dates of completion 1365 and renewal 1370, and a version identifier 1375 are entered for association with the document in the database.

Controls, such as icons 1385, may be provided to facilitate building a template. Each control activates a drop down list of standard choices in window 1390. The use of drop down lists simplify selection of keywords, textbook sources, medical terminology, ICD-9 information, restrictions, guideline sources (i.e., organizations endorsing guidelines), and information in other categories, thus providing a structured framework to ensure a consistent arrangement, selection and organization of information and to facilitate data entry.

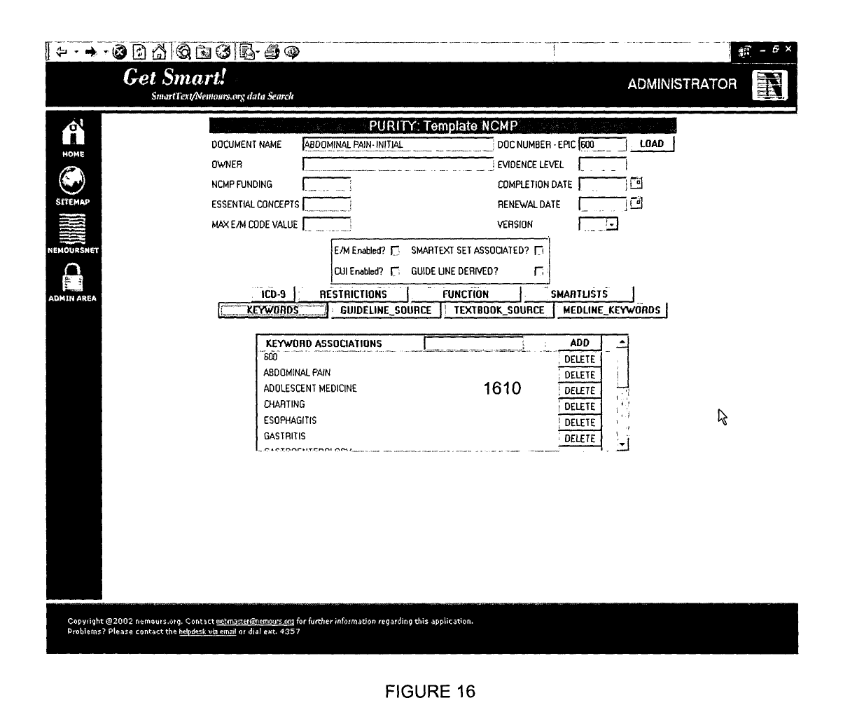

Illustratively, FIG. 16 shows the template of FIG. 13 with the icon “keyword” activated. A drop down list of keywords 1610 is presented in the window. The keywords may be added or deleted for association with a document and a particular topic area. Similarly, dropdown lists may be activated for the other categories of data (e.g., ICD-9, restrictions, function, smartlists, guideline_source, textbook_source and medline_keywords) for association with a document and a particular topic area.

Those skilled in the art will appreciate that the categories are exemplary and do not limit the scope of the invention. Additional, different and fewer categories may be made available. Additionally, information for a selected category need not be presented as part of a drop-down list. Other forms of presenting information for a selected category may be used without departing from the scope of the present invention.

Advantageously, the use of determined categories with determined information in the categories facilitates creation of a high quality medical document database. The categories and corresponding information ensure consistent characterization of documents using industry established terms and codes.

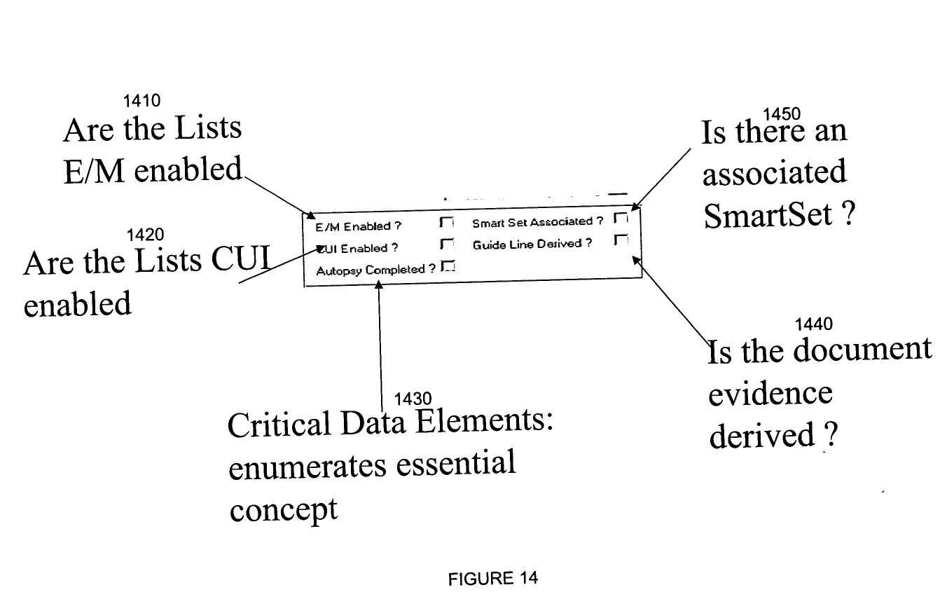

FIG. 14 illustrates the status of lists, such as whether E/M and CUI lists are enabled 1410 and 1420, the status of a critical data element (i.e., an essential concept), whether the document is evidence (guideline) derived 1440, whether an associated SmartSet list exists 1450. The purity fields may also show critical data elements, derived evidence, and a host of other information.

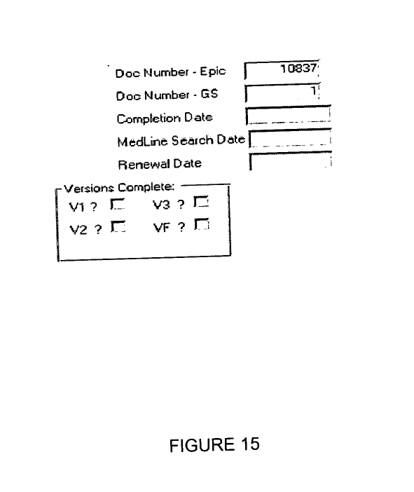

Illustratively, FIG. 15 shows a magnified portion of the template of FIG. 13 with an alternative version control indicator, namely, checkbox controls providing four possible versions. V1 may identify a first draft. V2 may a later version encoded with list control. V3 may identify a version that has consensus among users. VF may identify the final document.

Thus, the exemplary process managed using the back-end of the system entails defining topics, writing a paper providing a determined scope of coverage, encoding the paper for presentation using the system, submitting the paper for peer review, determining an evidence level based on validity, establishing granularity for encoding into the database, and associating various information with the document, such as a document name, an owner's name, funding information, essential concepts (e.g., using a CUI), a maximum Evaluation & Management code, a document number, the determined evidence level, dates of completion 1365 and renewal 1370, and a version identifier. The end result is a medical database having contents that have been validated through a peer review process, a searchable base of protocols, and links to literature references by a given medical topic. The database is populated and indexed with protocols for both diagnosis and treatments. The protocols are created and reviewed with research evidence, which provides for establishing confidence levels. The database information thus reflects consensus from experts and is evidence driven. It is then subsequently categorized and indexed into a database system. The information may then be subsequently accessed by keywords by practitioners from the patient point of care location.

Front-End User Interface

The front end of the system is referred to as a user interface. It provides a portal and accessibility to the medical database by practitioners at the point of care. Once a database in accordance with the invention is made available for use, it may be accessed and searched via the user interface.

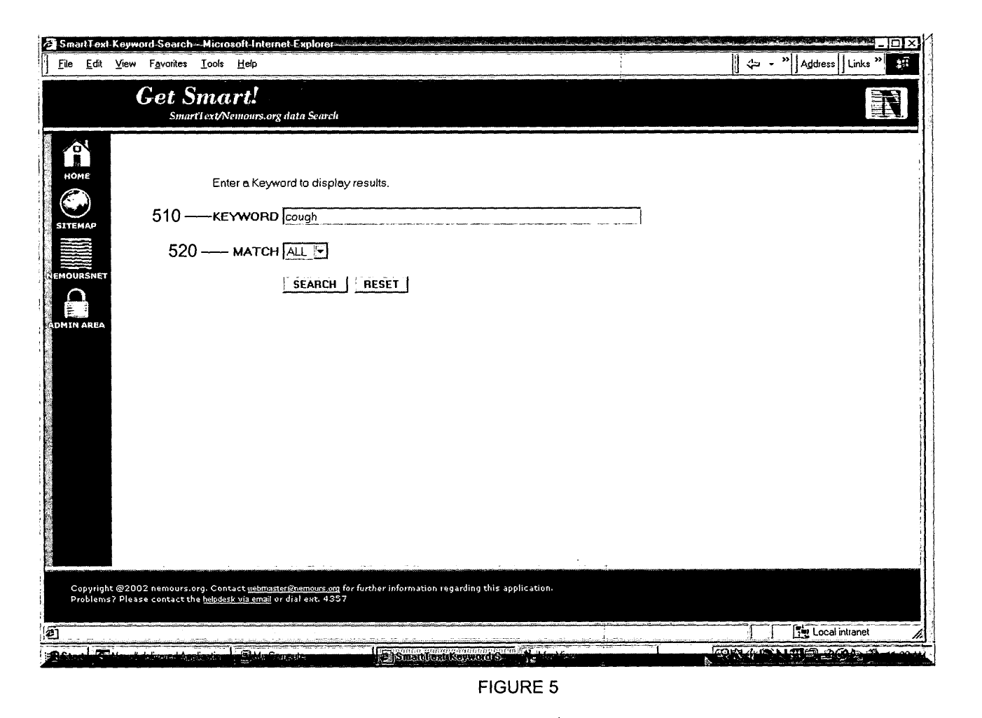

FIG. 5 illustrates an exemplary keyword search screen in accordance with the invention. A user may enter one or more search keywords 510, such as, for example, “cough”. The match control 520 indicates that “all” keywords must be found in each search result. Other match options may by way of example include “any”, indicating that any keyword may be found in the search results, or Boolean, if Boolean operators (e.g., AND and OR) are specified with the keywords. Those skilled in the art will appreciate that other database search interfaces that have a different format, different search options (e.g., natural searching), may be used without departing from the scope of the present invention.

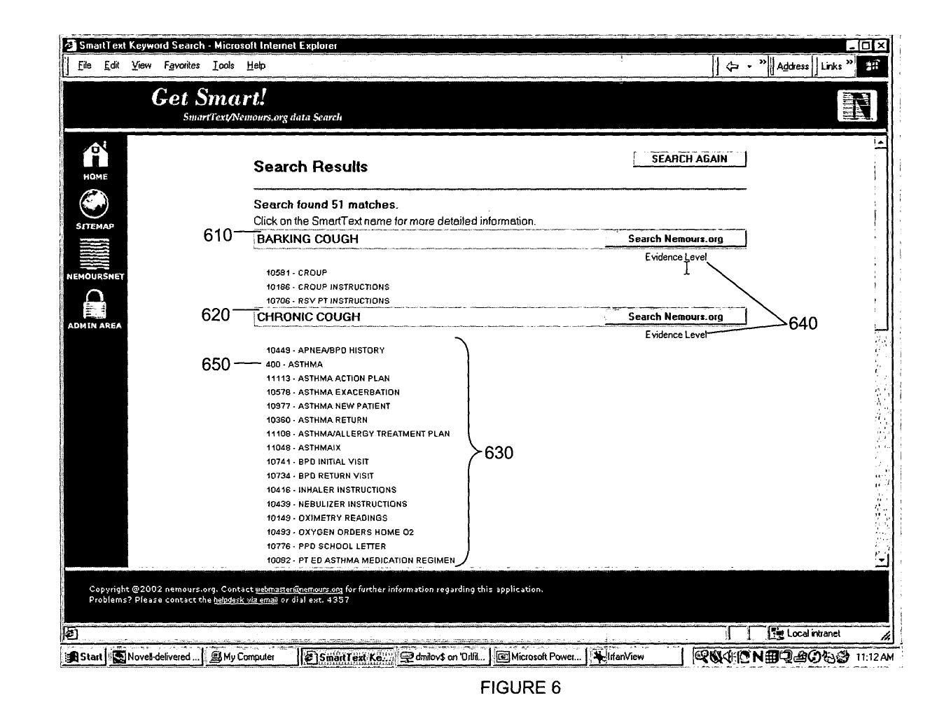

FIG. 6 illustrates possible search results for the exemplary “cough” query. Additionally, it offers subtopics 610 and 620 such as “barking coughs” or “chronic coughs” for focused searching, as well as smart text hyperlinks (i.e., hyperlinked identifiers) for documents (e.g., 630) under each subtopic. The subtopics may be the product of steps 200-220 of the methodology of FIG. 2. Evidence levels for each document, revealing the level to which they adhere to published standards, may be viewed by selecting the corresponding evidence level hyperlink 640. More detailed information, such as supporting literature, medical databases and best practice protocols, may be accessed from this screen by selecting smart text hyperlinks or the like.

Thus, the search results provide a convenient gateway to reliable information on the searched term. The information is presented in an orderly manner according to topics and subtopics to facilitate locating information truly of interest. In sharp contrast, other keyword searches tend to lump all search results into a single list, without any topics or subtopics to compartmentalize the information.

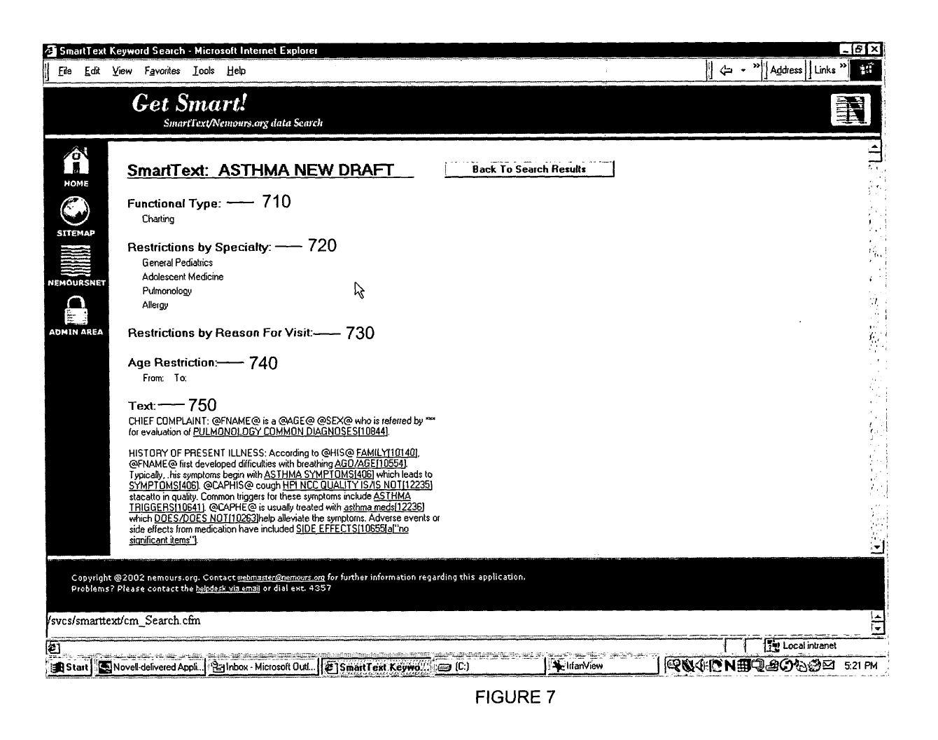

By way of example, selecting Smart Text “400-Asthma” 650 in the search results of FIG. 6, may lead to a page containing more detailed information and hyperlinks to additional resources pertaining to asthma, such as the draft page shown in FIG. 7. The page includes various categories of information, some of which may be blank if no information is available for that category for that Smart Text subject. By way of example and not limitation, the categories may include a functional type description 710 (i.e., the type of document), specialty information 720, restrictions according to reasons for visit 730, age restrictions 740 and text 750. The text may include plain text, data, codes, hyperlinks, graphical information, other forms of expression or any combination of any of the foregoing. Those skilled in the art will readily appreciate that the draft text template in FIG. 7, provides a structured approved framework for a practitioner to enter information into a patient's chart. The text includes links to acceptable choices for many of the variables, such as PULMONOLOGY COMMON DIAGNOSES [ 108441]. Links to supporting asthma citations in relevant literature may also be provided. Thus, the user interface may present patient charts for basic patient information and history and facilitate updates.

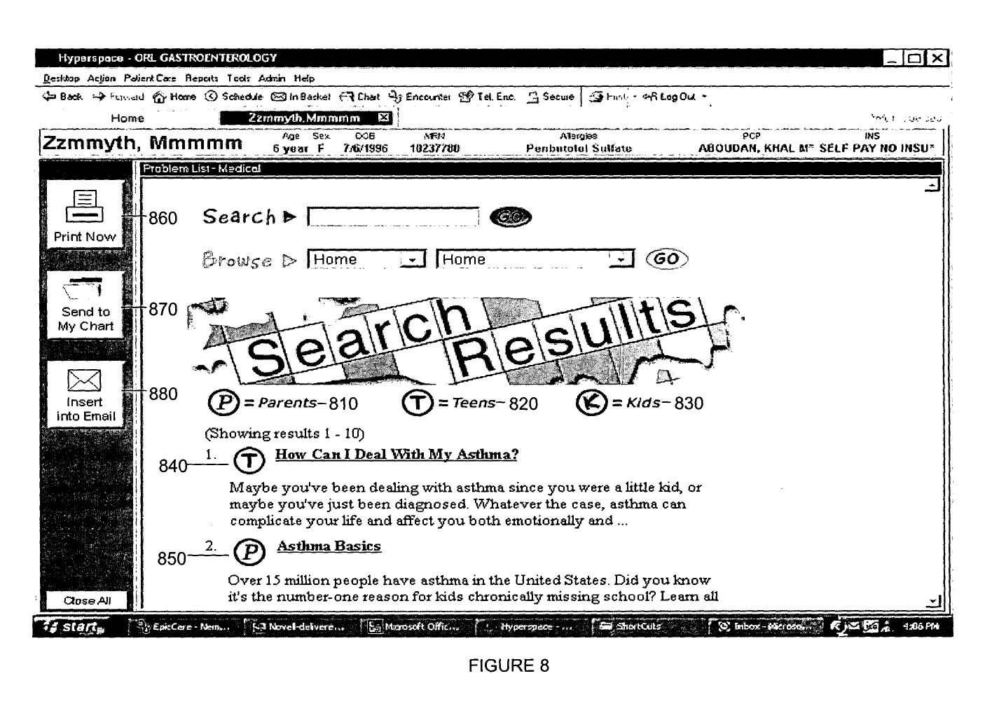

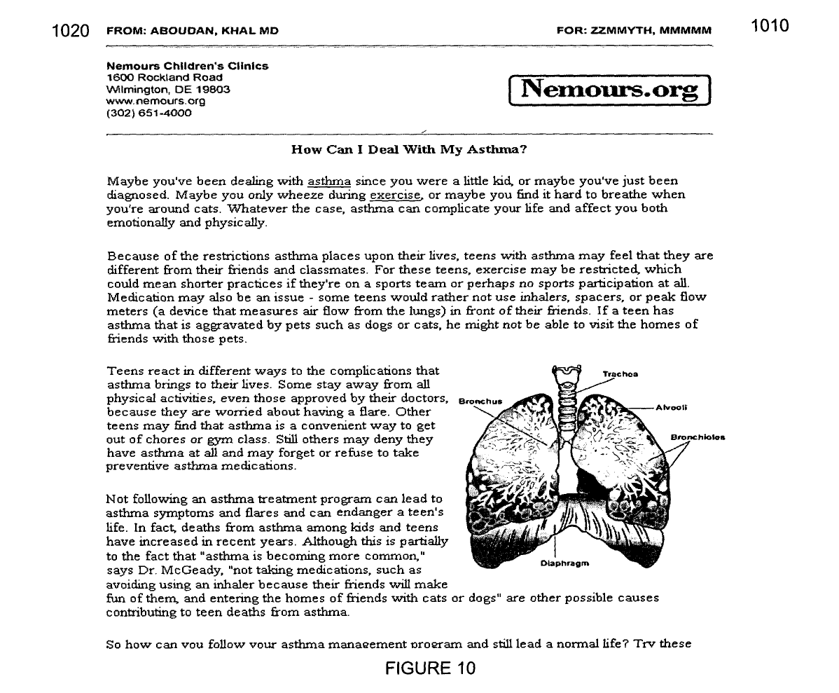

Referring now to FIG. 8, results of a search for educational information concerning asthma is shown. The results are tagged for suitability to a particular patient age category on a topic. The exemplary choices identified for suitability by age bracket include K for “kids”, P for “parents”, and T for “teens.” Of course, other designations, such as age ranges, could be employed to establish suitability by age. A document may be printed 860, sent to a patient's chart folder for record-keeping purposes 870 or delivered via email 880. If a document is printed, it may be co-branded in a printer friendly way (with or without using pre-printed letterhead) at the point of care as shown in FIG. 10. Other types of documents may include informed consent and drug information at the point of care.

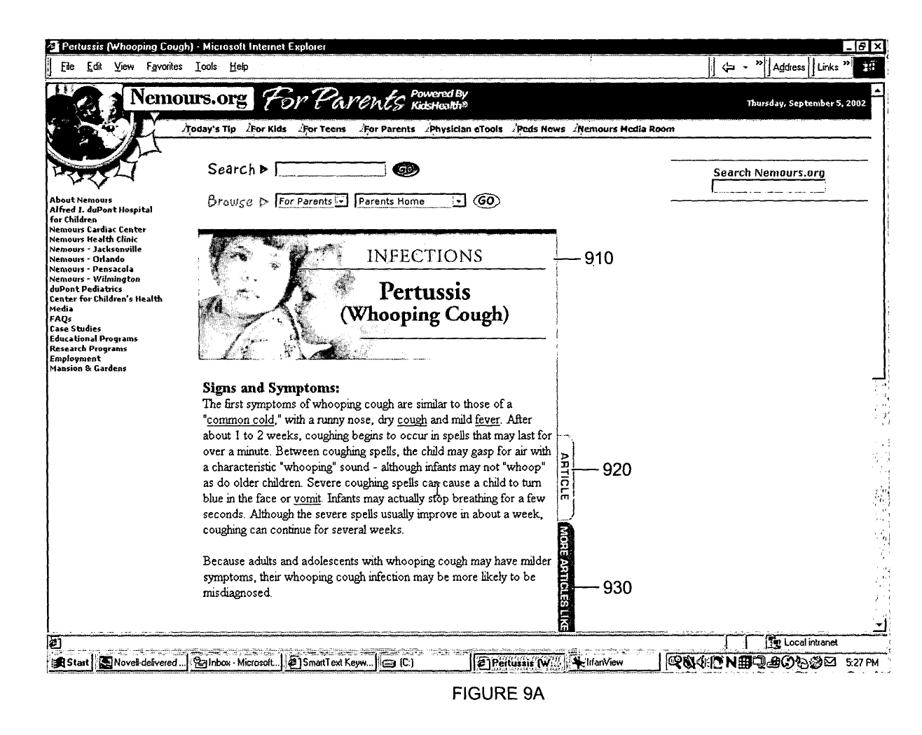

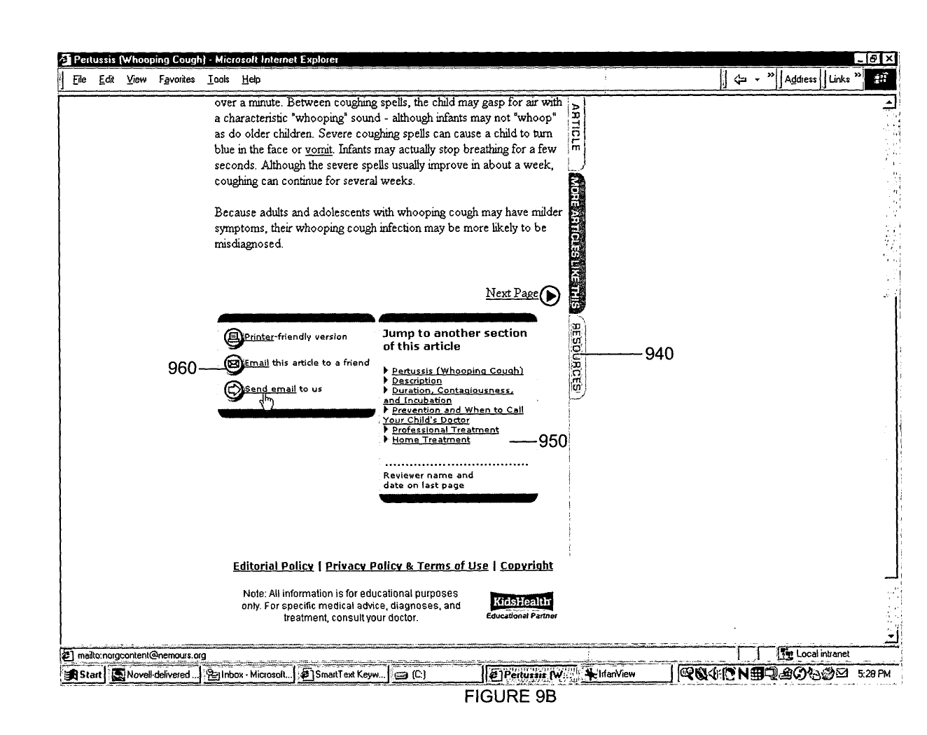

As another example, FIGS. 9A and 9B illustrate a parent-oriented educational article 910 on “whooping cough.” The article is web accessible, and includes links to information on underlined key terms. A tab 920 controls access to the article. Other tabs control access to related articles 930 and other resources 940. Hyperlinks 950 provide convenient access to other pages of the article. Additionally, options for printing, delivery via email or contacting the sponsoring organization (e.g., Nemours Children's Clinic) via email are provided.

The exemplary system and method thus enable creating and using a medical database having contents validated through peer review. The result is an extensive searchable database of protocols and links to literature references by a given medical topic. The database may populated and indexed with protocols for both diagnosis and treatments. The protocols may be created and reviewed with research evidence, which provides for establishing confidence levels. It may then subsequently be categorized and indexed into a database system. This information may be accessed by keywords by practitioners from the patient point of care location.

The database can be queried as necessary by medical personnel and others to associate a medical condition with a patient's symptoms or to provide standardized protocols minimizing variation for use in diagnosing a patient. Treatments can also be viewed that have been identified as most relevant to the symptoms. In this manner, medical personnel within an organization are provided with consistent, uniform, and confident diagnosis of conditions. Also, in this way, personnel can have assurance of convenient access to diagnosis and treatment protocols at the point of care. Medical personnel can be assured that the information has been reviewed by experts and indexed so that the most acceptable and proper manner of diagnosis and treatment has already been researched and prioritized, and that proper care is given to the diagnosis of the patient.

In use by a practitioner, the database search interface may provide directing questions for focusing the medical personnel to appropriate symptom categories. Links to supporting literature and protocols may also be provided based upon keyword queries.

While the invention has been described in terms of various embodiments, implementations and examples, those skilled in the art will recognize that the invention can be practiced with modification within the spirit and scope of the appended claims.

We claim the following:

1. A computer implemented medical database comprising:
a plurality of medical documents, each of said plurality of documents having protocol information associated therewith; and
an evidence level associated with each of said plurality of documents, said evidence level being a measurement of the validity of the protocol information for a document.

2. A computer implemented medical database according to claim 1, wherein:
the evidence level is based upon a plurality of factors, said factors including one or more of the following:
controlled study data,
cross-over trial data, and
placebo study data, and
common practice data.

3. A computer implemented medical database according to claim 2, wherein:
each evidence level is determined by a consensus among peers.

4. A computer implemented medical database according to claim 3, wherein:
each evidence level equals a percentage from 0% to 100%.

5. A computer implemented medical database according to claim 4, further including links to said protocol information associated with each of said plurality of documents.

6. A computer implemented medical database according to claim 5, further including one or more concept unique identifiers associated with each of said plurality of documents.

7. A computer implemented medical database according to claim 6, further including one or more evaluation and management codes associated with each of said plurality of documents.

8. A computer implemented medical database according to claim 7, further including:
a computer-implemented user interface configured to access the computer implemented medical database, and
computer program coding for each of said plurality of documents, said computer program coding being configured to enable presentation of the document using the computer implemented user interface.

9. A computer implemented medical database according to claim 8, further including:
one or more templates, each of said one or more templates being configured for entry of the each of said plurality of medical documents, concept unique identifiers, and evaluation and management codes in the database.

10. A computer implemented medical database according to claim 9, further including:
a document type identifier associated with each of said plurality of medical documents.

11. A computer implemented medical database according to claim 10, wherein the documents type identifier includes an indication of age for an intended reader of one or more of said plurality of documents.

12. A method for creating a medical database, said method comprising steps of:
assigning a topic;
writing a document on the topic;
submitting the document to peers for review and assignment of an evidence level; and
entering the document and the assigned evidence level for the document in a computer accessible database.

13. The method according to claim 12, said method further wherein the assigned evidence level is based upon a plurality of factors, said factors including one or more of the following:
controlled study data,
cross-over trial data, and
placebo study data, and
common practice data.

14. The method according to claim 13, wherein the assigned evidence level is determined by a consensus among peers.

15. The method according to claim 14, said method further including steps of assigning a concept unique identifier with the document and entering the assigned concept unique identifier in the database.

16. The method according to claim 15, said method further including steps of assigning a evaluation and management code with the document and entering the assigned evaluation and management code in the database.

17. The method according to claim 16, said method further including steps of assigning a critical data element with the document and entering the assigned critical data element in the database.

18. The method according to claim 17, said method further including steps encoding the document into a format compatible with a user interface.

19. A computer implemented medical database comprising a database means for storing a plurality of medical documents, associated protocol information, and associated evidence levels, each of said plurality of documents having protocol information associated therewith, and each of said plurality of documents having an evidence level associated therewith.

20. A computer implemented medical database according to claim 19, further comprising a template for entering the plurality of medical documents, associated protocol information, and associated evidence levels into the database.
